(19) United States
(12) Patent Application Publication
(10) Pub. No.: US 2005/0141741 A1
(43) Pub. Date: Jun. 30, 2005

(54) Method to optimize energy consumption in a hearing device as well as a hearing device

(76) Inventor: Gerard Van Oerle, Uster (CH)

Correspondence Address: PEARNE & GORDON LLP, 1801 EAST 9TH STREET, SUITE 1200, CLEVELAND, OH, 44114-3108, US

(21) Appl. No.: 10/749,292

(22) Filed: Dec. 30, 2003

(51) Int. Cl. H04R 25/00

(52) U.S. Cl. 381/323; 381/312

(57) ABSTRACT

A method is disclosed to optimize energy consumption in a hearing device in which one of several hearing programs can be selected, as well as a hearing device. The method comprises the steps of taking into account knowledge of computing power needed by the selected hearing program for adjusting a clock frequency (f_{CL}) for a clock signal (CL) and possibly also the supply voltage (VCC, VMEM) driving processing units (1) of the hearing device, and, furthermore, by adjusting the clock frequency (f_{CL}) of the clock signal (CL) and possibly also of the supply voltage (VCC, VMEM) as soon as the corresponding hearing program is activated. The present invention has the advantage that power consumption can dramatically be reduced because only the absolutely necessary energy is used by the processing units.

### FIELD OF THE INVENTION

The present invention is related to a method to optimize energy consumption in a hearing device as well as a hearing device.

### BACKGROUND OF THE INVENTION

Hearing devices are small scale portable devices that operate under battery power. Consequently, energy consumption is an important issue when designing hearing devices. Several approaches to reduce power consumption have therefore been proposed.

A first known method is disclosed in WO 02/07 480, in which a hearing aid is described with a power management circuitry. According to this known teaching, the hearing aid can be operated in two different operational modes, at least one of which is a power saving mode. The switching from one mode to another is performed to reduce power consumption when appropriate. Basically, the power management circuitry observes the incoming acoustical signal, which represents the sound picked up by the microphone, and decides whether the signal is important to the hearing device user—which results in switching to the normal operational mode or which results in staying in the normal operational mode, respectively—, or whether the incoming signal is of no importance to the hearing device user—which results in switching to the sleep mode or which results in staying in the sleep mode, respectively. Accordingly, there is full power consumption by the hearing aid, whenever an important incoming signal is detected by the power management circuitry. In other words, power consumption is only reduced while the hearing aid is in sleep mode.

Other state of the art is described in U.S. Pat. No. 5,111,506, in a paper of Philippe Mosch et al. entitled “A 660-μW 50-Mops 1-V DSP for a Hearing Aid Chip Set” (IEEE Journal of Solid-State Circuits, Vol. 35, No. 11, November 2000, pp. 1705-1712) and in a cover story published by Linda Geppert and Tekla S. Perry entitled “Transmeta's magic show” (IEEE Spectrum, May 2000, pp. 26-33).

U.S. Pat. No. 5,111,506 teaches a hearing aid with a multiple channel network in which each channel comprises an amplifier unit. To reduce power usage, each of the amplifier circuits is coupled to programmable biasing circuitry by which the current applied to the amplifier may be adjusted to compensate for deficiencies in the operating characteristics of the amplifier circuits caused by variations in the processes used to manufacture the integrated circuits. The energy savings resulting from this teaching are miniscule.

The above-mentioned paper by Mosch et al. gives an overview of the available measures to reduce power consumption of integrated circuits, in particular of integrated circuits in portable devices as for example in hearing devices.

Finally, general information is given in the above-mentioned cover story of the magazine “IEEE Spectrum” regarding the most recent developments in connection with the creation of fast low-power integrated circuits. It has been proposed to monitor software applications as they are running. The result of the monitoring is used to adjust both the supply voltage and the clock frequency such that each application runs only as fast as it must to get its task done. The monitoring of applications is performed by a specialized hardware, implemented in the so-called Crusoe processor, in addition to so-called Code Morphing software which allows further reductions in power consumption by utilizing capabilities available only in the Crusoe hardware. The power management technology provides Code Morphing software with the ability to adjust Crusoe's supply voltage and clock frequency on the fly depending on the demands placed on the Crusoe processor by software. Because power varies linearly with clock speed and with the square of voltage, adjusting both can produce cubic reductions in power consumption, whereas conventional CPUs can adjust power merely linearly, namely by only adjusting the clock frequency. The Crusoe processor and its Code Morphing software have a wide range of applications which results in a rather complicated design and cost intensive implementation. Further details of this technology are disclosed in WO 01/53 921.

It is therefore an object of the present invention, to provide a method to optimize power consumption in a hearing device, which method is easily implemented and has, at the same time, a high impact on energy savings.

### SUMMARY OF THE INVENTION

A method is disclosed to optimize energy consumption in a hearing device in which one of several hearing programs can be selected, as well as a hearing device. The method comprises the steps of taking into account knowledge of computing power needed by the selected hearing program for adjusting a clock frequency for a clock signal and possibly also the supply voltage driving processing units of the hearing device, and, furthermore, by adjusting the clock frequency of the clock signal and possibly also of the supply voltage as soon as the corresponding hearing program is activated. The present invention has the advantage that power consumption can dramatically be reduced because only the absolutely necessary energy is used by the processing units.

By taking into account of knowledge of computing power needed by a selected hearing program for adjusting a clock frequency driving processing units of the hearing device, and by adjusting the clock frequency as soon as the corresponding hearing program is activated, power consumption can dramatically be reduced, because only the absolutely necessary energy is being used by the processing units.

In further embodiments of the present invention, the output voltage of the source supplying energy to the processing units and memory units of the hearing device is also adjusted. In addition, the simultaneous use of charge storage devices, e.g. capacitors, is proposed to generate a supply voltage for processing units processing acoustic signal as well as for a memory supply voltage which is used to program non-volatile memory. Generally, the supply voltage is lower than a battery voltage, and the memory supply voltage is higher than the battery voltage.

The present invention is not only directed to a method to optimize energy consumption in a hearing device but also to a hearing device itself, whereas under the term hearing device, it is intended to include hearing aids as used to compensate for a hearing impairment of a person, as well as to all other acoustic communication systems, such as radio transceivers and the like. Furthermore, the present invention is also suitable to be incorporated into implantable devices.

### DETAILED DESCRIPTION OF THE DRAWINGS

In the following, the present invention will be further explained by referring to drawings showing exemplified embodiments of the present invention. It is shown in:

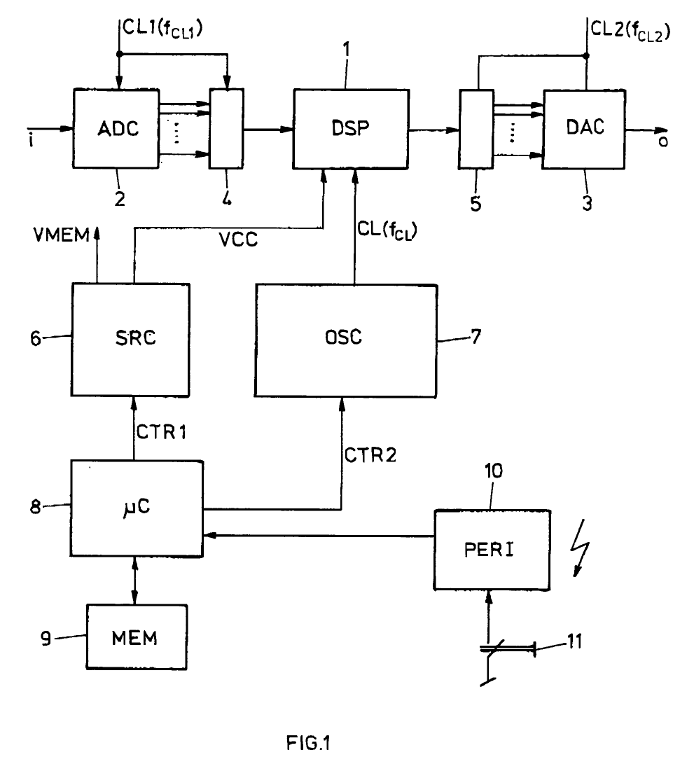

FIG. 1, schematically, a block diagram of a hearing device according to the present invention,

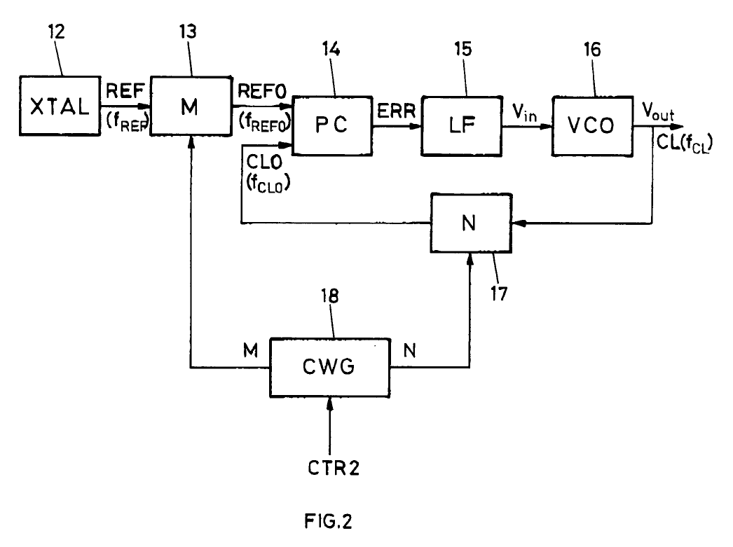

FIG. 2 a block diagram of a programmable clock signal generator used to generate a clock signal with adjustable frequency,

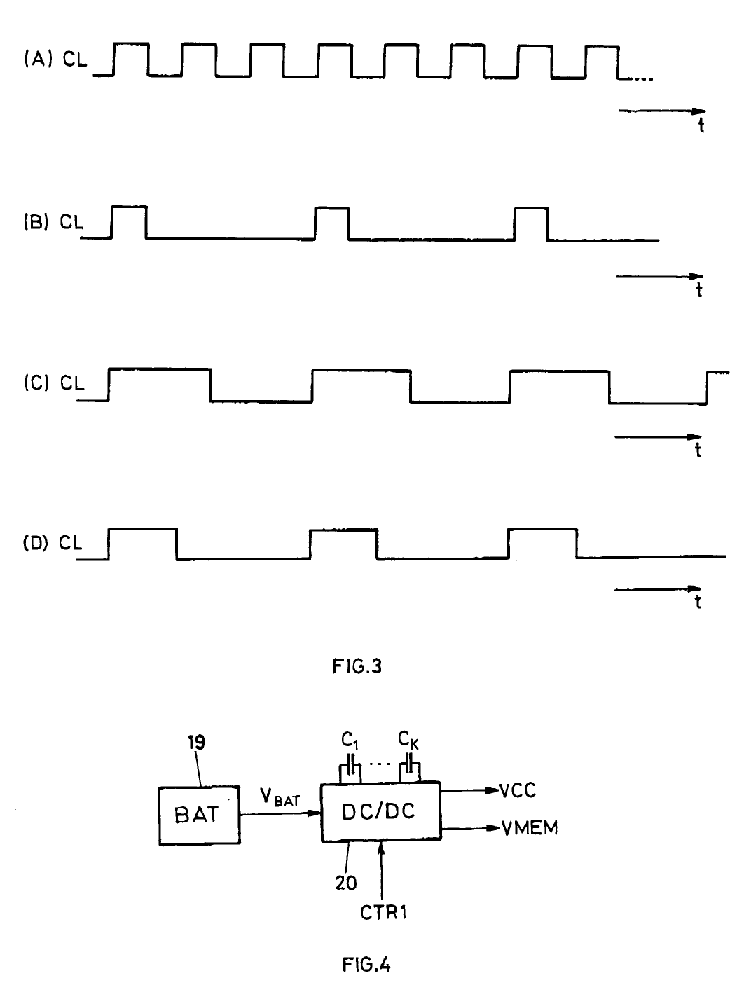

FIG. 3 several time diagrams of a clock signal used to control processing units in the hearing device, and

FIG. 4 a block diagram of a power source unit used to generate a digital supply voltage as well as a memory supply voltage for a non-volatile memory.

### DETAILED DESCRIPION OF SEVERAL EMBODIMENTS OF THE INVENTION

FIG. 1 shows a block diagram of a hearing device according to the present invention. In the block diagram, the different units and their interconnections are only shown as necessary, i.e. in order to fully explain the present invention, and in a schematic manner.

An acoustic signal is picked up by a microphone (not shown in FIG. 1) and fed to an analog-to-digital converter 2 which is clocked at a clock rate f_{CL1}. The sampled acoustic input signal is processed in a processing unit 1 in which a selected algorithm, often referred to as hearing program, is applied to the input signal. A synchronizing unit 4, which is clocked at the same clock rate f_{CL1}, is provided between the analog-to-digital converter 2 and the processing unit 1. The task of the synchronizing unit 4 will be explained below. The processed acoustic signal is then, possibly via another synchronizing unit 5, fed to a digital-to-analog converter 3 in which an analog output signal o is generated, the latter being fed to a speaker which is often called receiver (not shown in FIG. 1). The synchronizing unit 5 and the digital-to-analog converter 3 are clocked at a clock rate f_{CL2}. Therewith, the actual signal path for the signal being processed in the hearing device has been described.

The analog-to-digital converter 2 and the synchronizing unit 4 as well as the digital-to-analog converter 3 and the synchronizing unit 5 are operated at a steady clock rate f_{CL1} or f_{CL2}, respectively, in order to prevent aliasing or other distortions in the acoustic signals. The two synchronizing units 4 and 5 are used to transfer data between components with different clock rates, i.e. between the analog-to-digital converter 2 and the processing unit 1 and between the latter and the digital-to-analog converter 3.

All other components represented in FIG. 1 are auxiliary components with regard to the above-described signal path, and are only shown in so far as they are important in connection with the present invention. Further components might exist in certain hearing device implementations as well as other arrangements of components in the signal path might be possible without departing from the concept of the present invention.

The auxiliary components represented in FIG. 1 consist of a control unit 8, a power source 6, an oscillator unit 7, a memory unit 9 and a peripheral unit 10. The control unit 8 takes control not only of the auxiliary components but also of the components belonging to the signal path, in particular of the processing unit 1 although connections from the control unit 8 to the components of the signal path are not shown by FIG. 1. The power source 6 receives instructions from the control unit 8 over the connection CTR1. According to these instructions, a supply voltage VCC is generated in the power source 6 for supplying energy to the processing unit 1 and possibly to other components. In other words, the supply voltage VCC can be adjusted to a desired value. This is the first means to control power consumption by the hearing device.

The control unit 8 is further connected to the oscillator unit 7 over a connection CTR2. Similar to the adjustment of the power source 6, the control unit 8 is able to adjust a clock frequency f_{CL} for the processing unit 1 over the oscillator unit 7 which is the second means to control power consumption in the hearing device.

The control unit 8 is further connected to the memory unit 9 in which relevant data is stored which is used in connection with the power optimization in the hearing device. The kind of information stored in the memory unit 9 is described below.

Finally, the control unit 8 is further connected to the peripheral unit 10 through which certain selections and/or adjustments can be controlled either by a remote control operated by the hearing device user or by a switch at the hearing device housing, which switch can also be operated by the hearing device user.

A possible influence on the hearing device mode of operation lies in the selections of one of the possible hearing programs. It is well known in the state of the art that—depending on the momentary acoustic surround situation—a certain hearing program is selected either automatically by the hearing device or manually by the hearing device user. In this connection, reference is made to the teaching disclosed in WO 01/22 790.

Each selectable hearing program has an underlying algorithm which forms the basis for the processing being performed in the processing unit 1. It is a fact that different processing power is needed depending on the complexity of the underlying algorithm. The present invention makes use of these different needs of processing power by incorporating this knowledge into the adjustment of the clock frequency f_{CL} and possibly also the adjustment of the supply voltage VCC. Furthermore, the present invention takes advantage of the fact that the selected underlying algorithm calls for a more or less steady processing power, in other words, no fluctuation in processing power needs must be expected during execution of a specific program. Therefore, an optimized clock frequency f_{CL}, which is used to drive the processing unit 1 of the hearing device, can be fixed to a value which is just sufficient to timely execute an algorithm of a certain hearing program.

For every hearing program, a clock frequency f_{CL} can be determined for the processing unit 1 beforehand, i.e. before implementing the hearing program in the hearing device. The clock frequencies or a corresponding value, respectively, are then stored in the memory unit 9 from which they can be retrieved whenever a new hearing program has been selected via the peripheral unit 10 or automatically chosen by the hearing device itself.

The same procedure applies for the selection of the supply voltage VCC in the source unit 6. In other words, for each hearing program, a certain supply voltage VCC—or a corresponding value—is stored in the memory unit 9, which supply voltage VCC or value, respectively, is retrieved whenever a new hearing program has been selected via the peripheral unit 10 or automatically chosen by the hearing device itself.

While one embodiment of the present invention is intended to adjust the clock frequency f_{CL} as well as the supply voltage VCC, another embodiment is directed to only adjusting the clock frequency f_{CL} while the supply voltage VCC remains unchanged at a certain preset level.

If a power optimization scheme based on frequency adjustment of the clock signal CL is intended to be implemented, a preferred embodiment of the oscillator unit 7 (FIG. 1) will have an internal structure as depicted in FIG. 2. FIG. 2 shows a programmable clock signal generator that operates according to the principle of a so-called digital phase locked loop (DPLL) to generate a clock signal with a variable, selectable frequency. The functionality of a typical DPLL is explained in the following with reference to FIG. 2.

A signal REF with a certain fixed reference frequency f_{REF} is generated by a crystal oscillator 12. This signal REF is applied to a first divider unit 13, which produces an output signal REF0 whose frequency f_{REF0} is M-times lower than that of the corresponding input signal REF, i.e. f_{REF0}=f_{REF}/M, M being an integer number. The reduced frequency signal REF0 is subsequently fed to one of the inputs of a phase comparator 14 (often also referred to as “phase detector” in the literature). At the same time, an output signal CL0 from a second frequency divider unit 17 is applied to another input of the phase comparator 14. The phase comparator 14 generates an error signal ERR—representative of a frequency offset (i.e. frequency difference) between the reduced frequency signal REF0 and the output signal CL0 of the second frequency divider unit 17—at its output. This error signal ERR is fed to a loop filter 15 before being fed to a voltage controlled oscillator 16 (VCO) as a control voltage Vᵢₙ. A frequency f_{CL} of an output signal Vₒᵤₜ generated by the VCO 14 is proportional to the control voltage Vᵢₙ. The output signal Vₒᵤₜ generated by the voltage controlled oscillator 16 is used as a clock signal CL to drive the processing unit 1 (as show in FIG. 1). At the same time, the signal CL is also fed back to above-mentioned second divider unit 17, which generates the output signal CL0, whose frequency f_{CL0} is N-times lower than that of the input signal CL, i.e. f_{CL0}=f_{CL}/N, where N is an integer. This feedback circuit reaches its steady state when the frequencies of the two signals REF0 and CL0 applied to the inputs of the phase comparator 14 are the same, i.e., when f_{REF0}=F_{CL0}, resulting in an error signal ERR with a value of zero. Once this is the case the clock signal CL will have a stable frequency of f_{CL}=f_{REF}·N/M, as can easily be calculated.

Each time a specific hearing program has been selected—whereby this selection process can either be automatically performed by the hearing device itself or carried out manually through intervention by the wearer of the hearing device—the control unit 8 (FIG. 1) will retrieve from a memory unit 9 information regarding the minimal necessary clock speed f_{CL} required to execute in real-time an algorithm associated with the chosen hearing program. This information will be processed and converted into a control signal CTR2 that is communicated to the programmable clock generator 7. A control word generator 18 within the unit 7 will receive the control signal CTR2 and use it in conjunction with knowledge of the reference frequency f_{REF} to derive two divisor values, namely N and M, such that a clock signal CL can be generated with the desired minimal operating frequency f_{CL} required by the processing unit 1 in order to execute the selected algorithm correctly, i.e. in a timely manner. Using the exemplary preferred embodiment presented in FIG. 2, the frequency f_{CL} of the clock signal CL can be set to any rational multiple N/M of the reference frequency f_{REF}. The resolution of achievable clock frequency values will depend on the word lengths selected for representation of the two divisors N and M.

In a further, simplified embodiment of the present invention, only a relatively small number of different target clock frequencies will be used. For such an embodiment, M is set to 1, for example, which means that the first divider unit 12 could be removed in order to reduce complexity.

It should be noted that the above described mechanism of generating a clock signal with programmable frequency was for illustrative purposed only and in no way should this exemplary embodiment limit the scope or general spirit of the present invention.

In case the adjustment of the clock frequency f_{CL} is intended to be implemented, a possible course for the clock signal CL will have a 50%-duty cycle in one embodiment. This will be further explained in connection with FIGS. 3A, 3B, 3C and 3D.

FIG. 3A shows a course for the clock signal CL at a certain rate while a 50%-duty cycle is used. To reduce the clock frequency f_{CL} certain pulses can be left out, which results in a duty cycle of fare less than 50%. A possible course for such a clock signal CL with clock frequency f_{CL} is represented in FIG. 3B.

It must be pointed out that such a course is not suitable if the supply voltage VCC is also adjusted, i.e. reduced, because the slopes of the pulses cannot be less steep than to the ones in FIG. 3A.

If one wants to adjust or reduce, respectively, the supply voltage VCC, the course of the clock must therefore also be adjusted at least to some extent. For a maximum reduction of the supply voltage VCC, the duty cycle must be changed to essentially 50%. A course for the clock signal CL, which has a reduced frequency compared to the one shown in FIG. 3A but which has a 50%-duty cycle, is represented in FIG. 3C.

In FIG. 3D, a course for the clock signal CL is shown with a 33%-duty cycle to illustrate the possibility for a certain reduction of the supply voltage VCC. Even though the maximum reduction, as it is possible with a 50%-duty cycle, is not achievable, a duty cycle of less than 50% is worth striving for reducing the supply voltage correspondingly.

For the sake of completeness it is pointed out that duty cycles of more than 50% are also possible. Again, a corresponding limited reduction of the supply voltage VCC is the result by increasing the duty cycle towards 100%.

A further embodiment of the present invention which is based on the concept of varying the supply voltage VCC for the processing unit 1 (FIG. 1) in response to the selection of a specific hearing program in order to reduce power consumption requires the use of a programmable power source as depicted schematically in FIG. 4.

FIG. 4 shows an exemplary internal block diagram of the power source 6 from FIG. 1. This power source comprises a battery 19 and a DC/DC-(Direct-Current-to-Direct-Current) converter 20. The DC/DC-converter 20 is used to up- or down-convert the battery voltage V_{BAT} to different, programmable supply voltages VCC and memory supply voltages VMEM required to run the processing unit 1 and non-volatile memory (not shown in FIGS. 1 and 3), respectively. Setting of the supply voltages VCC and of the memory supply voltages VMEM is performed by the control unit 8 in response to a specific hearing situation or operational state and communicated to the DC/DC converter 20 via the control signal CTR1. If non-volatile memory such as flash memory or EEPROM (Electrically Erasable Programmable Read-Only Memory) is being used, the memory supply voltage VMEM must usually be set to a higher value than the battery voltage V_{BAT} typically employed in hearing devices, i.e. the memory supply voltage VMEM is generated through an up-conversion of V_{BAT}. On the other hand, the supply voltage VCC supplied to the processing unit 1 should be set to the lowest possible value sufficient for this unit to execute the selected hearing program correctly, in order to save power, i.e. the supply voltage VCC is derived from the battery voltage V_{BAT} via a down-conversion of the battery voltage V_{BAT}.

A possible implementation of a DC/DC converter 20 comprises a capacitive multiplier or divider, respectively, which, depending on whether the battery voltage V_{BAT} applied to the input of the unit 20, needs to be up- or down-converted to generate the desired supply voltage VCC and the desired memory supply voltage VMEM, has a multiplication factor A≧1 or 0<A<1, respectively. Such a capacitive multiplier and divider, respectively, uses K capacitors C₁, . . . , C_{K} to store and transfer energy, whereby capacitive voltage conversion is obtained through periodically switching these capacitors C₁, . . . , C_{K}. This type of voltage conversion device is therefore often termed “charge pump” by those skilled in the art.

In this aspect of the present invention, another object is to minimize the number K of capacitors C₁, . . . , C_{K} required to generate different supply voltages VCC and memory supply voltages VMEM. This is due to the fact that the capacitors C₁, . . . , C_{K} are typically rather bulky discrete components, mounted externally to the integrated circuits which incorporate most of the circuitry contained in modern hearing devices, and hence consume a large amount of space which is very limited in these highly miniaturized hearing devices. Typically, the more different multiplication factors the DC/DC converter 20 needs to implement the more capacitors C₁, . . . , C_{K} are required. The number of multiplication factors A must therefore carefully be selected, and the number K of capacitors C₁, . . . , C_{K} must thereby be constrained to the point where an increase of the number K no longer has a significant positive impact on power savings. Unfortunately, even more capacitors C₁, . . . , C_{K} are needed when the DC/DC converter 20 must simultaneously up-convert the battery voltage V_{BAT} to a higher memory supply voltage VMEM for the non-volatile memory and, on the other hand, down-convert the battery voltage V_{BAT} to a lower supply voltage VCC for the processor unit 1. In order to avoid having to use two independent charge pumps—each with its own set of capacitors C₁, . . . , C_{K}—in such situations, a system according to the present invention employs, for example, only a single charge pump to generate only one of the necessary supply voltages VCC or one of the necessary memory supply voltages VMEM at any moment in time. This is based on the fact that accessing (i.e. reading from or writing to) the non-volatile memory happens fairly infrequently. During these infrequent and brief instances the charge pump is used to up-convert the battery voltage V_{BAT} to a higher memory supply voltage VMEM for the non-volatile memory and the supply voltage VCC for the processing unit 1 directly comes from the battery via a linear regulator. As soon as the non-volatile memory is no longer active, the charge pump is reassigned to down-converting the battery voltage V_{BAT} to a lower supply voltage VCC. This scheme is still very power efficient, since the short, intermittent periods where the processing unit 1 draws its power directly from the battery via the linear regulator have little impact on the average power consumption of the hearing device. Furthermore, by appropriate choice of the values for the capacitors C₁, . . . , C_{K}, the same small set of capacitors C₁, . . . , CK can be used to produce both multiplication factors A≧1 as well as such with 0<A<1.

An embodiment of the present invention in which power consumption is minimized by simultaneously adapting both the clock frequency f_{CL} as well as the supply voltage VCC required to run the processing unit 1 (FIG. 1) in response to the hearing program in use at any given time will incorporate both a programmable clock generation unit 7 as well as a programmable voltage generation unit 6. The specific implementation of either of these two units 6 and 7 can be variants of the exemplary schemes described above.

1. A method to optimize energy consumption in a hearing device in which one of several hearing programs can be selected, the method comprising the steps of
receiving information regarding a selected hearing program, and
adjusting a clock frequency of a clock signal driving processing units of the hearing device,
wherein knowledge of computing power needed by the selected hearing program is taken into account for adjusting the clock frequency.

2. The method of claim 1, further comprising the step of
adjusting a supply voltage supplying processing units with energy in the hearing device,
wherein knowledge of computing power needed by the selected hearing program is taken into account for adjusting the supply voltage.

3. The method of claim 2, further comprising the step of generating the supply voltage from a battery voltage that is higher than the supply voltage.

4. The method of claim 2, further comprising the step of generating a memory supply voltage from a battery voltage that is lower than the memory supply voltage.

5. The method of claim 2, further comprising the step of either generating the supply voltage or a memory supply voltage from a battery voltage at any point in time.

6. The method of claim 2, further comprising the step of using a charge storing device, with at least one capacitor, to generate the supply voltage and/or a memory supply voltage.

7. The method of claim 6, further comprising the step of using the capacitor to generate the supply voltage as well as the memory supply voltage.

8. The method of one of the claims 1 to 7, further comprising the step of generating essentially a 50%-duty cycle for the clock signal.

9. A method to optimize energy consumption in a hearing device in which one of several hearing programs can be selected, the method comprising the steps of
receiving information regarding a selected hearing program, and
adjusting a supply voltage supplying processing units with energy in the hearing device,
wherein knowledge of computing power needed by the selected hearing program is taken into account for adjusting the supply voltage.

10. The method of claim 9, further comprising the step of
adjusting a clock frequency of a clock signal driving processing units of the hearing device,
wherein knowledge of computing power needed by the selected hearing program is taken into account for adjusting the clock frequency.

11. The method of claim 9, further comprising the step of generating the supply voltage from a battery voltage that is higher than the supply voltage.

12. The method of claim 9, further comprising the step of generating a memory supply voltage from a battery voltage that is lower than the memory supply voltage.

13. The method of claim 9, further comprising the step of either generating the supply voltage of a memory supply voltage from a battery voltage at any point in time.

14. The method of claim 9, further comprising the step of using a charge storing device, with at least one capacitor, to generate the supply voltage and/or a memory supply voltage.

15. The method of claim 14, further comprising the step of using the capacitor to generate the supply voltage as well as the memory supply voltage.

16. The method of one of the claims 9 to 15, further comprising the step of generating essentially a 50%-duty cycle for the clock signal.

17. A hearing device comprising
a processing unit driven by a clock signal,
a control unit, and
an oscillator unit,
wherein the control unit is operatively connected to the oscillator unit which is operatively connected to the processing unit, wherein the clock signal generated by the oscillator unit is adjustable by the control unit via the oscillator unit by taking into account knowledge of computing power needed by a selected hearing program.

18. The hearing device of claim 17, further comprising a source unit wherein the control unit is operatively connected to the source unit, and wherein a supply voltage to supply the processing unit with energy is adjustable by the control unit via the source unit by taking into account knowledge of computing power needed by a selected hearing program.

19. The hearing device of claim 18, further comprising a voltage converter provided in the source unit, the voltage converter being able to generate the supply voltage as well as a memory supply voltage whereas, wherein the supply voltage is lower than a battery voltage and the memory supply voltage is higher than the battery voltage.

20. The hearing device of claim 19, wherein the voltage converter is able to either generate the supply voltage or the memory supply voltage at any point in time.

21. The hearing device of claim 20, further comprising a charge storing device with at least one capacitor operatively connected to the voltage converter.

22. The hearing device of claim 21, wherein the charge storing device is used to generate the supply voltage as well as the memory supply voltage.

23. The hearing device of one of the claims 17 to 22, wherein essentially a 50%-duty cycle for the clock signal is generatable in the oscillator unit.

24. A hearing device comprising
a processing unit for processing acoustic signals,
a control unit, and
a source unit generating a supply voltage,
wherein the control unit is operatively connected to the source unit which is operatively connected to the processing unit, wherein the supply voltage generated by the source unit is adjustable by the control unit via the source unit by taking into account knowledge of computing power needed by a selected hearing program.

25. The hearing device of claim 24, further comprising an oscillator unit, wherein the control unit is operatively connected to the oscillator unit and wherein a clock signal generated by the oscillator unit is adjustable by the control unit via the oscillator unit by taking into account the knowledge of computing power needed by a selected hearing program.

26. The hearing device of claim 24, further comprising a voltage converter provided in the source unit, the voltage converter being able to generate the supply voltage as well as a memory supply voltage, wherein the supply voltage is lower than a battery voltage and the memory supply voltage is higher that the battery voltage.

27. The hearing device of claim 26, wherein the voltage converter is able to either generate the supply voltage or the memory supply voltage at any point in time.

28. The hearing device of claim 27, further comprising a charge storing device with at least one capacitor operatively connected to the voltage converter.

29. The hearing device of claim 28, wherein the charge storing device is used to generate the supply voltage as well as the memory supply voltage.

30. The hearing device of one of the claims 24 to 29, wherein essentially a 50%-duty cycle for the clock signal is generatable in the oscillator unit.
